(19) United States
(12) Patent Application Publication
(10) Pub. No.: US 2009/0204411 A1
(43) Pub. Date: Aug. 13, 2009

(54) IMAGE PROCESSING APPARATUS, VOICE ASSISTANCE METHOD AND RECORDING MEDIUM

(75) Inventors: Takeshi Morikawa, Takarazuka-shi (JP); Toshimichi Iwai, Kitakatsuragi-gun (JP); Kei Shigehisa, Amagasaki-shi (JP); Kaitaku Ozawa, Itami-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/369,136

(22) Filed: Feb. 11, 2009

(30) Foreign Application Priority Data
Feb. 13, 2008 (JP) 2008-032462

(51) Int. Cl. G10L 21/00; G06K 15/00

(52) U.S. Cl. 704/275; 358/1.16

(57) ABSTRACT

An image processing apparatus comprises: a voice input portion; a memory that stores in itself as voice data, voice of a plurality of users for voice assistance, which is inputted by the voice input portion; a selection portion that selects voice data applied for a login user among the voice data stored in the memory, if information should be given by voice; and a voice output portion that outputs voice corresponding to the selected voice data.

This application claims priority under 35 U.S.C. § 119 to Japanese Patent Application No. 2008-032462 filed on Feb. 13, 2008, the entire disclosure of which is incorporated herein by reference in its entirety.

### BACKGROUND OF THE INVENTION

1. Field of the Invention

The present invention relates to an image processing apparatus and a voice assistance method capable of giving by voice, information such as operations, statuses of the apparatus itself and etc., and a computer readable recording medium having a voice assistance program recorded therein to make a computer execute processing.

2. Description of the Related Art

The following description sets forth the inventor's knowledge of related art and problems therein and should not be construed as an admission of knowledge in the prior art.

Image processing apparatuses capable of giving by voice, information such as operations, statuses of the apparatus itself and etc., are conventionally known.

For example, as suggested by Japanese Unexamined Laid-open Patent Application No. 2006-338589, there is an image processing apparatus comprising a controller that makes a display output on itself a print setting screen including a plurality of print setting items that can be set from an operation portion, and also makes a voice output portion output information about at least one of the plurality of print setting items when it is selected by user, for the purpose of enabling not only healthy people but also visually-disadvantaged people with impaired visual functions or other disadvantaged people to configure a print setting rapidly and easily via a predetermined print setting screen. With this image processing apparatus, information about a preferable print setting item can be obtained by voice, via the print setting screen to set a print condition.

In addition, as suggested by Japanese Unexamined Laid-open Patent Application No. 2003-140880, there is an image processing apparatus capable of giving by voice, a notice of operation results of the apparatus itself.

However, quite often, voice outputted from such a conventional image processing apparatus capable of giving information by voice is hard to hear or recognize depending on users, since it lacks variety and is not changed depending on users. This kind of problem could occur not only to visually-disadvantaged people but also to healthy people, and thus this conventional image processing apparatus is desired to be improved from the point of view of user conveniences.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The Preferred embodiments of the present invention can significantly improve upon existing methods and/or apparatuses.

It is an objective of the present invention to provide an image processing apparatus capable of giving by voice information about operations, statuses of the apparatus itself and etc. in an easy-to-understand and easy-to-hear manner.

It is another objective of the present invention to provide a voice assistance method of the image processing apparatus, capable of giving by voice information about operations, statuses of the apparatus itself and etc. in an easy-to-understand and easy-to-hear manner.

It is yet another objective of the present invention to provide a computer readable recording medium having a voice assistance program recorded therein to make a computer execute a voice assistance process.

According to a first aspect of the present invention, an image processing apparatus comprises:
a voice input portion;
a memory that stores in itself as voice data, voice of a plurality of users for voice assistance, which is inputted by the voice input portion;
a selection portion that selects voice data applied for a login user among the voice data stored in the memory, if information should be given by voice; and
a voice output portion that outputs voice corresponding to the selected voice data.

According to a second aspect of the present invention, a voice assistance method comprises:
storing in a memory as voice data, voice of a plurality of users for voice assistance, which is inputted by a voice input portion;
selecting appropriate voice data applied for a login user among the voice data stored in the memory, if information should be given by voice; and
outputting voice corresponding to the selected voice data.

According to a third aspect of the present invention, a computer readable recording medium having a voice assistance program recorded therein to make a computer of an image processing apparatus execute:
storing in a memory as voice data, voice of a plurality of users for voice assistance, which is inputted by a voice input portion;
selecting voice data applied for a login user among the voice data stored in the memory, if information should be given by voice; and
outputting voice corresponding to the selected voice data.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a view showing an example of a configuration of an entire file sharing system;

FIG. 2 is a perspective view showing an exterior of an image processing apparatus according to one embodiment of the present invention;

FIG. 3 is a block diagram showing an electrical configuration of the image processing apparatus according to one embodiment of the present invention;

FIG. 4 is a view showing an example of BOXes and etc. created in a hard disk;

FIG. 5 is a view showing an example of a structure of a BOX database;

FIG. 6 is a view showing an example of a user information database;

FIG. 7 is a view showing an example of an active job database;

FIG. 8 is a view showing an example of a functional configuration of the image processing apparatus;

FIG. 9 is a flowchart to explain an entire procedure executed in the image processing apparatus;

FIG. 10 is a view showing an example of an initial menu screen;

FIG. 11 is a flowchart to explain a user entry procedure executed when a file is stored in a BOX;

FIG. 12 is a flowchart to explain a user voice input/output procedure executed when a mode is set;

FIG. 13 is a view showing a BOX selection screen;

FIG. 14 is a view showing a BOX name entry screen;

FIG. 15 is a view showing a file name entry screen;

FIG. 16 is a view showing an example of a base screen displayed when the copy mode is selected to specify an application to be used;

FIG. 17 is a view showing an entry screen to configure an economy mode when the copy mode is selected;

FIG. 18 is a view showing an entry screen to configure an applied mode when the copy mode is selected;

FIG. 19 is a flowchart to explain a voice output procedure executed when a file is called out from a BOX by user;

FIG. 20 is a view showing a BOX selection screen displayed when a BOX is called out;

FIG. 21 is a view showing a file selection screen;

FIG. 22 is a view showing an administrator mode setting screen;

FIG. 23 is a view showing an example of another administrator mode setting screen; and

FIG. 24 is a view showing an example of yet another different administrator mode setting screen.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

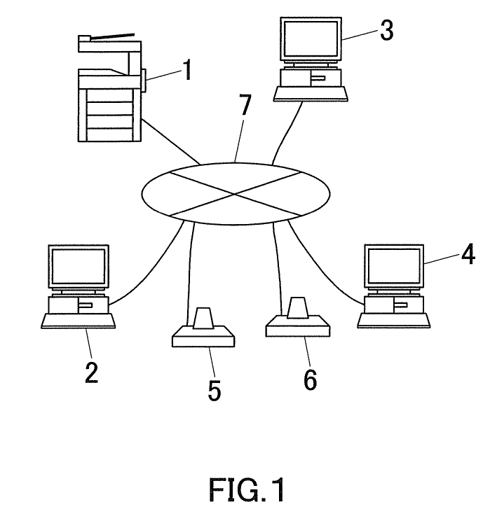

FIG. 1 is a view showing an entire file sharing system in which an image processing apparatus according to one embodiment of the present invention is employed.

As shown in FIG. 1, the file sharing system comprises: an image forming apparatus 1 as an image processing apparatus; one or a plurality of a client terminal 2, a client terminal 3 and/or a client terminal 4 that is (are) a personal computer(s); one or a plurality of a FAX terminal 5 and/or a FAX terminal 6; a communication line 7; and etc.

The image forming apparatus 1 and the client terminals 2, 3 and 4 have their own computer names such as “PC001”, “PC002” . . . assigned as identification information in order to identify from one BOX to another. In place of such computer names, IP addresses may be used as identification information. Meanwhile, the FAX terminals 5 and 6 have their own telephone numbers of so-called fixed-line phones or IP phones, given thereto.

The image forming apparatus 1, the client terminals 2, 3 and 4, and the FAX terminals 5 and 6 are capable of being connected to each other via the communication line 7. A LAN, Internet, a dedicated line, a public line or etc. is employed as the communication line 7. TCP/IP (Transmission Control Protocol/Internet Protocol), FTP (File Transfer Protocol), POP3 (Post Office Protocol version 3), SMTP (Simple Mail Transfer Protocol), IPP (Internet Printing Protocol), IEEE802.3 that is a wired LAN standard, IEEE802.11 that is a wireless LAN standard, a G3 (Group 3) or G4 (Group 4) FAX standard, and etc. are employed as protocols or communication standards.

With this file sharing system, users using the image forming apparatus 1 and the client terminals 2, 3 and 4 can share data recorded in a hard disk of the image forming apparatus 1. In place of a personal computer, a workstation, a PDA (Personal Digital Assistant), a cell-phone terminal and etc. can be employed as the client terminals 2, 3 and 4.

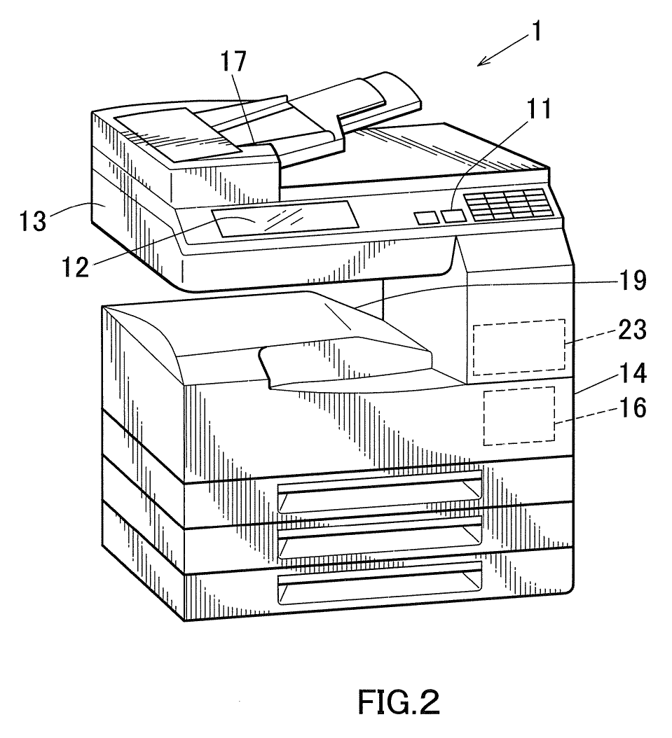

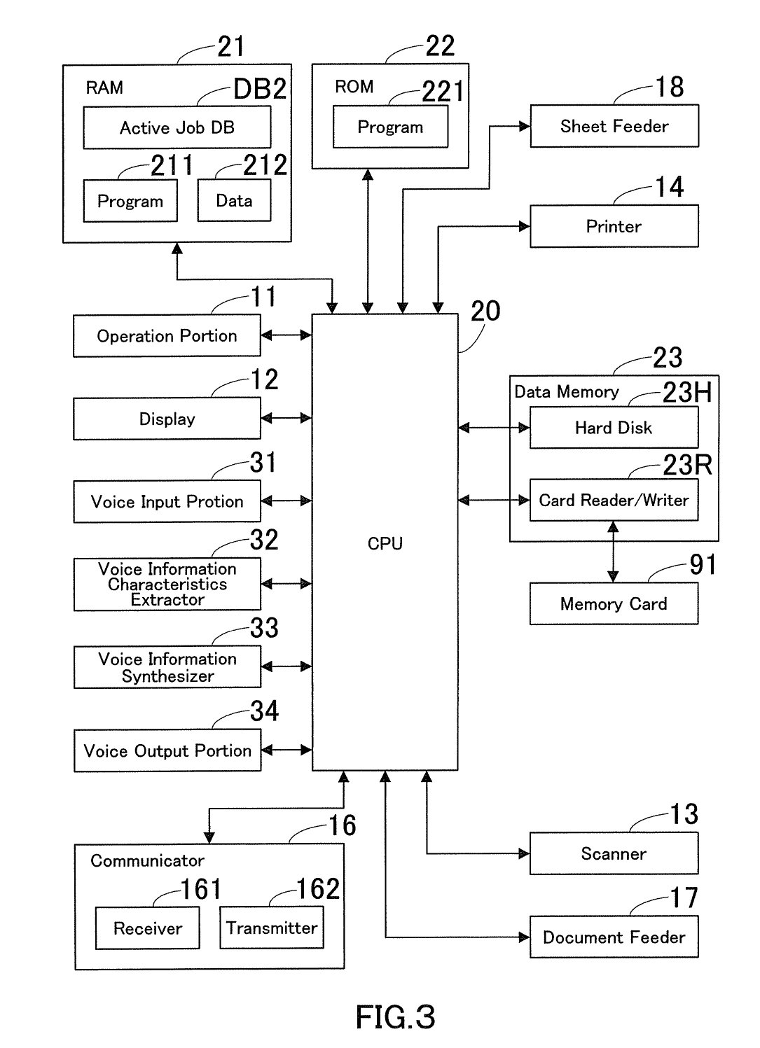

FIG. 2 is a perspective view showing an exterior of the image forming apparatus 1. FIG. 3 is a block diagram showing a hardware construction of the image forming apparatus 1.

The image forming apparatus 1 is a MFP (Multi Function Peripheral) that is a multifunctional digital machine collectively having the functions of copying, network-printing, scanning, facsimile, document server and etc.

As shown in FIG. 2 and FIG. 3, the image forming apparatus 1 comprises an operation portion 11, a display 12, a scanner 13, a printer 14, a communicator 16, a document feeder 17, a sheet feeder 18, a sheet discharge tray 19, a data memory 23, a CPU 20, a RAM 21, a ROM 22, a voice input portion 31, a voice information characteristics extractor 32, a voice information synthesizer 33, a voice output portion 34 and etc.

The operation portion 11 comprises: a plurality of keys to enter numbers, characters, symbols and etc.; a sensor that senses pressed keys; a transmission circuit that transmits to the CPU 20 signals indicating the sensed keys; and etc.

In addition, the operation portion 11 has a microphone as the voice input portion 31 and a speaker as the voice output portion 34, loaded thereon.

The display 12 displays on itself, a screen to give messages and instructions to users, a screen that allows users to enter settings and processes, a screen to show images formed by the image forming apparatus 1 itself and processing results, and other screens. In this embodiment, a touch panel is employed as the display 12, and if a user touches it by fingers, a location thereon is detected then signals indicating the detecting result are transmitted to the CPU 20.

As described above, the operation portion 11 and the display 12 serve as a user interface that allows users to operate the image forming apparatus 1 directly.

Meanwhile, the client terminals 2, 3 and 4 have an application program and a printer driver installed thereon to give instructions to the image forming apparatus 1. And thereby, users are allowed to remotely operate the image forming apparatus 1 by using the client terminals 2, 3 and 4.

The scanner 13 photoelectrically reads images such as photos, characters, illustrations, figures and etc. then generates digital image data (thickness data indicating RGB or Black thickness, in this embodiment). The image data obtained in this way above is used by the printer 14 for printing. Alternatively, it is converted to a file of a format such as TIFF (Tagged Image File Format) or PDF (Portable Document Format) then recorded in the data memory 23 or transmitted to the client terminal 2, 3 or 4. Alternatively, it is converted to FAX data then transmitted to the FAX terminal 5 or 6.

The printer 14 prints on recording sheets of paper, film or etc., images read by the scanner 13, images of image data received from the client terminals 2, 3 and 4, and images of FAX data received from the FAX terminals 5 and 6.

The communicator 16 comprises a transmitter 162, a receiver 161 and etc. and exchanges data with the client terminals 2, 3 and 4, and the FAX terminals 5 and 6. Meanwhile, a NIC (Network Interface Card), a modem, a TA (Terminal Adapter) or etc. is employed as a communication interface thereof.

The document feeder 17 is provided on the top of the body of the image forming apparatus 1, and is used to feed to the scanner 13 one or a plurality of pages of document sequentially.

The sheet feeder 18 is provided in the lower area of the body of the image forming apparatus 1, and is used to feed to the printer 14 appropriate recording sheets for images to be printed. The recording sheets carrying images printed thereon by the printer 14, in other words, the printed sheets, are discharged on the sheet discharge tray 19. Meanwhile, the printer 14 has a both-side printing mechanism loaded thereon to print images on both sides of sheets.

The data memory 23 comprises a hard disk 23H, a card reader/writer 23R and etc. The card reader/writer 23R reads out data from a memory card 91 such as a compact flash (registered trademark) or a smart media and writes data in the memory card 91. The memory card 91 is used to exchange data with the client terminals 2, 3 and 4 without using the communication line 7 and used to have a backup of data.

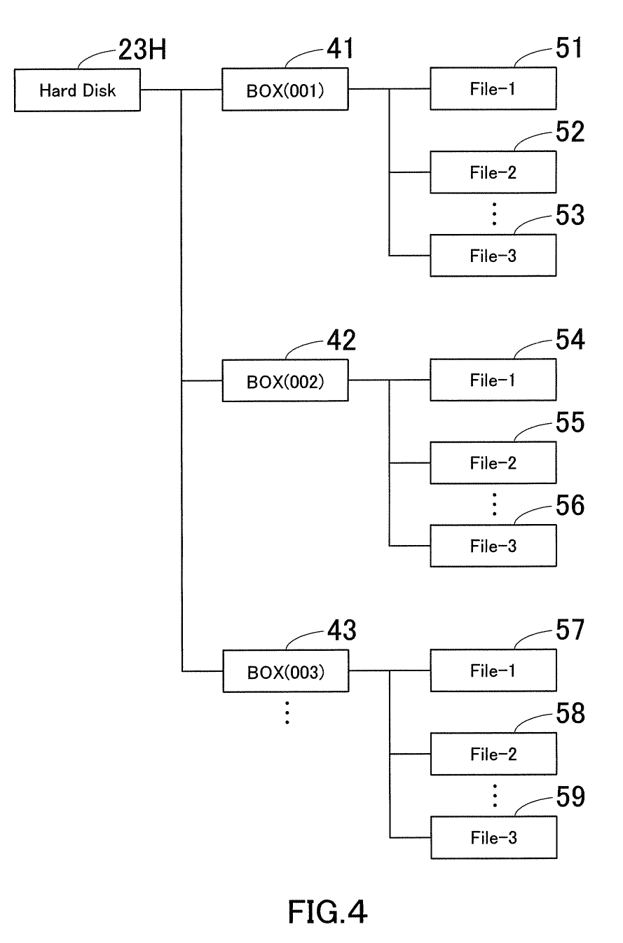

The hard disk 23H has in itself, as shown in FIG. 4, personal BOXes 41, 42 and 43 that are memory areas to store data as files, assigned to respective users.

The personal BOXes 41, 42 and 43 corresponds to “directories” or “folders” used in personal computers, workstations and etc. Hereinafter, these personal BOXes will be also referred to simply as “BOXes”.

The BOXes 41, 42 and 43 have their own BOX names assigned to identify from one BOX to another. In this embodiment, arbitrary 3-digit numbers (for example, “001”, “002” and “003”) are used as BOX names. Users can store files in their BOXes by transferring the files thereto from the client terminals 2, 3 and 4, and also can store files in their BOXes by setting the memory card 91 storing the files in itself into a slot of the card reader/writer 23R then copying the files. In addition, files can be stored in BOXes in the following ways.

For example, if a user issues an instruction to copy a document set on the document feeder 17, image data of an image read out from the document is converted into a file then the file is stored in a BOX of the user, by the image forming apparatus 1. In the same way, if a user issues an instruction to transmit to the client terminal 2, 3 or 4 image data of a document set on the document feeder 17, image data of an image read out from the document is converted into a file then the file is stored in a BOX of the user. If a user issues an instruction to print (network-print) a document from this user's using client terminal 2, 3 or 4, image data of the document received from the client terminal 2, 3 or 4 is stored as a file in a BOX 41, 42 or 43 of the user. If FAX data is received from the FAX terminal 5 or 6, the FAX data is stored as a file in a BOX 41, 42 or 43 of a user who is a recipient of that data. If a user issues an instruction to transmit to the FAX terminal 5 or 6 an image on a document set on the document feeder 17, image data of the image read out from the document is converted into a file then the file is stored in a BOX 41, 42 or 73 of the user.

A BOX database including files 51 through 59 to be stored in the BOXes 41, 42 and 43 is recorded in the hard disk 23H, and as shown in FIG. 5, it is comprised of “BOX name”, “BOX creator”, “data of voice inputted when BOX is created”, “file name”, “file creator” and “data of voice inputted when file is created”. The “BOX name” corresponds to identification information to identify the respective BOXes as described above, the “BOX creator” corresponds to users creating the BOXes, and the “data of voice inputted when BOX is created” corresponds to data of voice inputted when the BOXes are created, so that users could identify the BOXes with voice assistance. For example, the voice data to be outputted as “this is a BOX about Project A” is stored as the “data of voice inputted when BOX is created”, in the BOX “001”.

The “file name” corresponds to identification information to identify from one file to another among those stored in the same BOX. Accordingly, a plurality of files having the same file name cannot be stored in the same BOX but can be stored individually in different BOXes, as a matter of course. The “file creator” corresponds to users who create the files, and the “data of voice inputted when file is created” corresponds to data of voice inputted when the files are created and at least one function is specified by user voice.

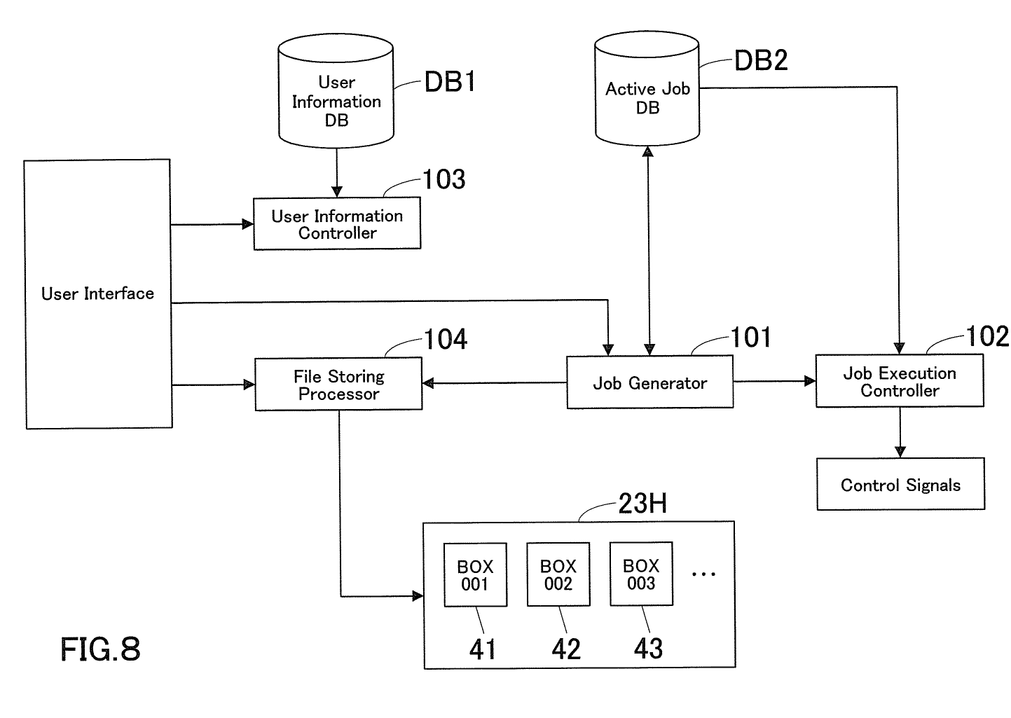

In addition, the hard disk 23H has a user information database DB1 (shown in FIG. 8) recorded therein.

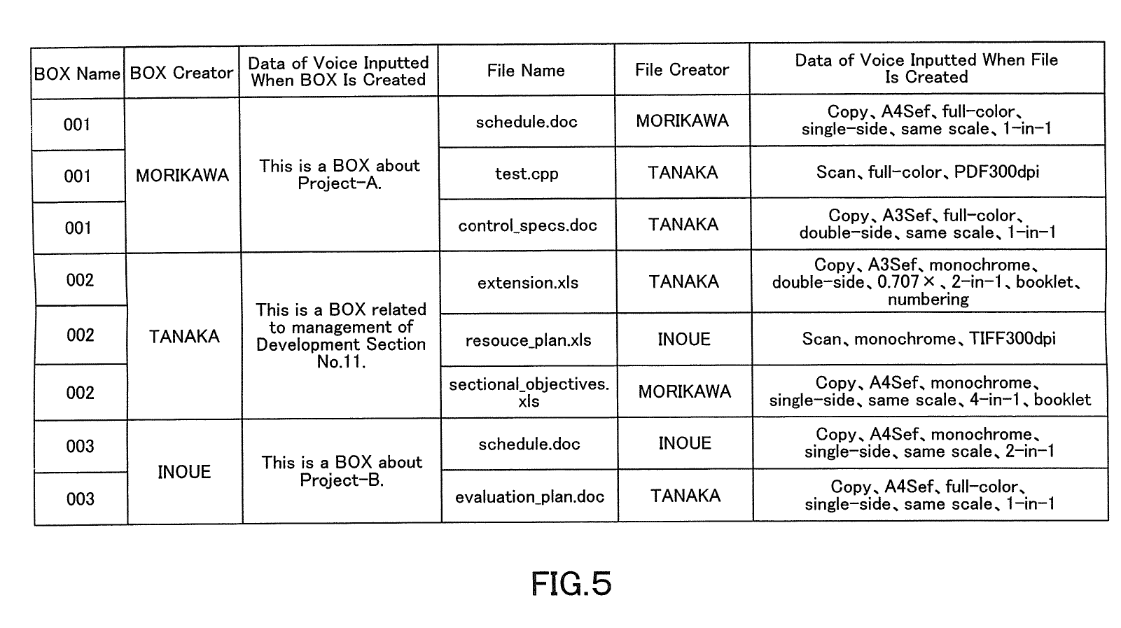

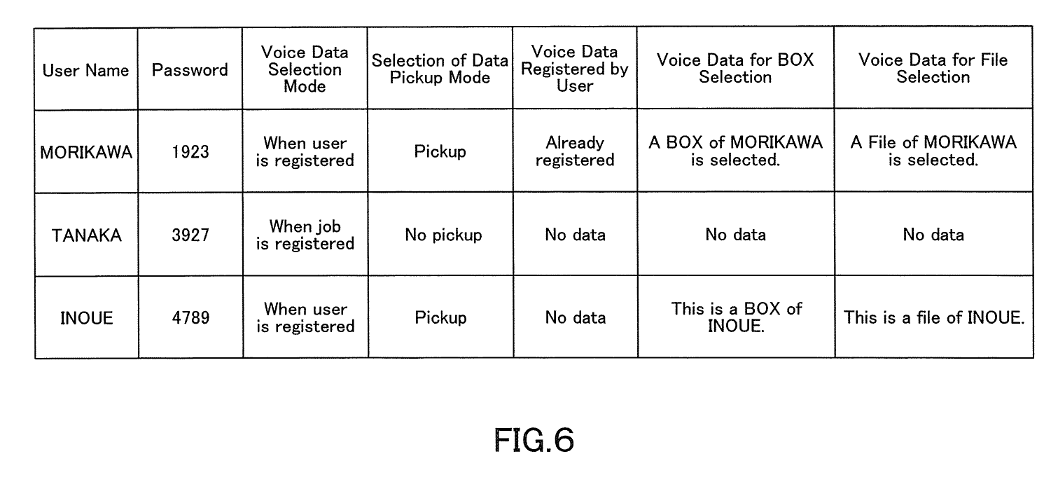

The user information database DB1 stores in itself information about users using the image forming apparatus 1, as shown in FIG. 6.

As shown in FIG. 6, the “user name” corresponds to identification information to identify respective users. The user names are used when users intend to login the image forming apparatus 1.

The “password” corresponds to user authentication (user validation) information that is used when users intend to login.

The “voice data selection mode” corresponds to whether data of voice inputted when user is registered or data of voice inputted when job is registered, should be used for voice assistance, and it can be selected according to user preference. If data of voice inputted when job is registered should be used, the “data of voice inputted when BOX is created” and the “data of voice inputted when file is created” stored in the BOX database (FIG. 5) mentioned above becomes available. Meanwhile, if data of voice inputted when user is registered should be used, data registered as “voice data for BOX selection” and “voice data for file selection” to be described later becomes available.

The “selection of data pickup mode” corresponds to whether entirely or partly, voice inputted when the user specifies the function by voice should be outputted, if at least one function is specified by user, and the “voice data selection mode” set for this user is “when job is registered”.

The “voice data registered by user” corresponds to voice data registered by users according to their preferences.

The “voice data for BOX selection” corresponds to fixed voice data to be outputted when a BOX is selected, and varies from user to user i.e. depending on BOX creators. The “voice data for file selection” corresponds to fixed voice data to be outputted when a file is selected, and varies from user to user i.e. depending on file creators. These two kinds of data become available if the “voice data selection mode” set therein is “when user is registered”.

The CPU 20 centrally controls the entire image forming apparatus 1 by executing a program stored in a recording medium such as the ROM 22 or etc.

The RAM 21 serves as an operation area for the CPU 20 to execute processing. Besides, in this embodiment, it temporarily stores in itself an active job database DB2, a program 211, data 212 and etc.

Furthermore, in this embodiment, it temporarily stores in itself: data received from the client terminals 2, 3 and 4, and the FAX terminals 5 and 6; data to be transmitted to the client terminals 2, 3 and 4, and the FAX terminals 5 and 6; data generated by the scanner 13; and other data. Meanwhile, a nonvolatile RAM may be used as the RAM 21.

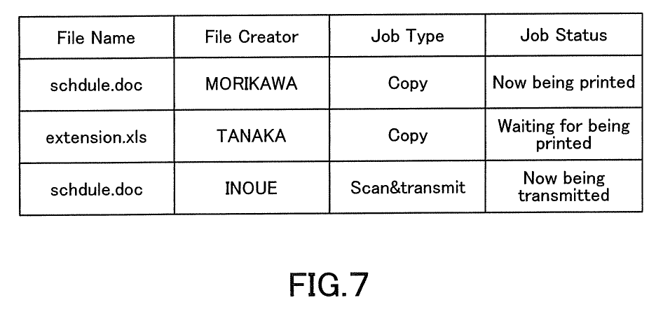

As shown in FIG. 7, the active job database DB2 recorded in the RAM 21 has information about processes (jobs) waiting for execution, stored thereon. And thus the active job database DB2 would be also referred to as information indicating a queue. In principal, jobs will be executed sequentially from the upper rows.

As shown in FIG. 7, the “file name” corresponds to file names to identify the respective jobs. The “file creator” corresponds to names of users creating the files. The “job type” corresponds to types of applications to be used for the jobs. The “job status” corresponds to current statuses of the jobs. The value “waiting for XXX” is stored as the “job status” of the jobs waiting for their turns coming around and execution.

The ROM 22 has programs and data to enable the basic functions of the image forming apparatus 1, such as image reading (scanning), document copy (copying), FAX data transmitting/receiving, network-printing, document server (BOX function) and etc., recorded therein.

In addition, the ROM 22 has programs and data to enable the respective functions of a job generator 101, a job execution controller 102, a user information controller 103, a file storing processor 104 and etc. shown in the functional configuration of the image forming apparatus 1, recorded therein. These programs and data may be partly or entirely installed on the data memory 23. In this case, the programs and data installed on the data memory 23 are loaded onto the RAM 21 according to requirement. These functions may be partly or entirely enabled by a processor (circuit).

The voice information characteristics extractor 32 extracts acoustic features (sound characteristics) and rhythmic features (length, pitch, intensity of sound) from data of voice inputted by users, when it is registered.

The voice information synthesizer 33 synthesizes data of different users' voice, based on the acoustic and rhythmic features extracted from the data of voice inputted by users.

As shown in FIG. 8, the job generator 101 converts into files, image data obtained by a scanning operation of the scanner 13, print data received from the client terminals 2, 3 and 4, and FAX data received from the FAX terminals 5 and 6, and thus generates files. The file storing processor 104 stores the generated files in predetermined BOXes.

The job execution controller 102 controls the respective portions of the image forming apparatus 1, so that jobs could be executed according to the queue of the active job database DB2. The user controller 103 performs user authentication about users trying to operate the image forming apparatus 1 to execute predetermined processes, registers their user information into the user information database, and controls voice input/output according to the user information.

Functions and operations of the job generator 101 will be further explained in details with reference to flowcharts, screens displayed on the display 12, and etc.

Meanwhile, programs to execute the respective procedures shown in the flowcharts are recorded in the ROM 22, the hard disk 23H of the data memory 23, or etc. And the CPU 20 controls the respective portions of the image forming apparatus 1 according to the programs, and thereby the respective procedures shown in the flowcharts are executed.

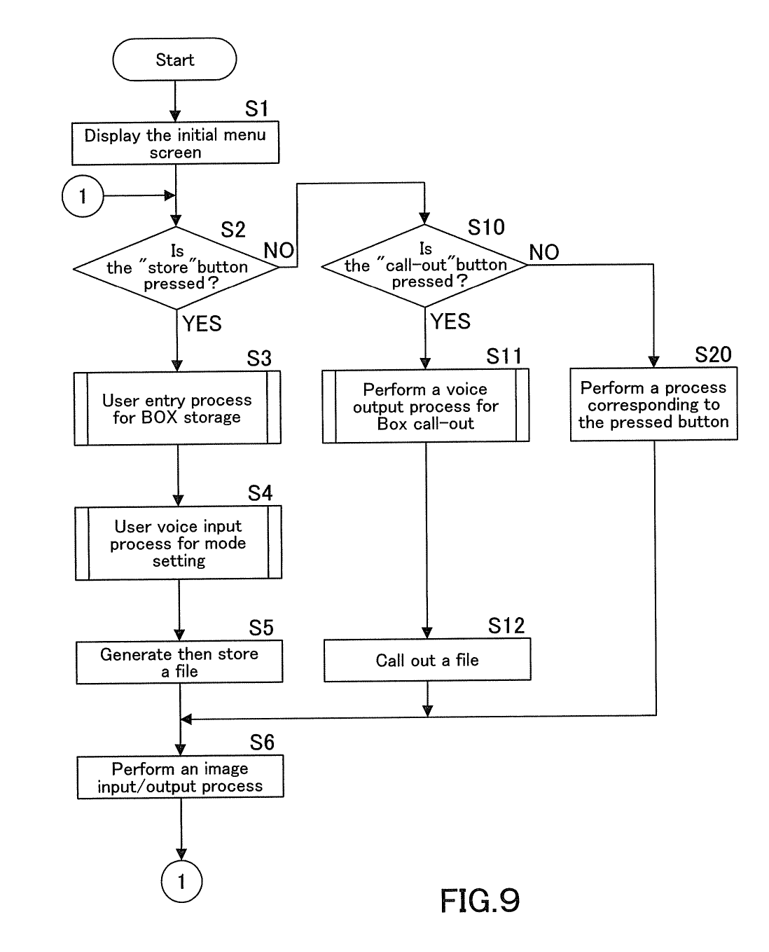

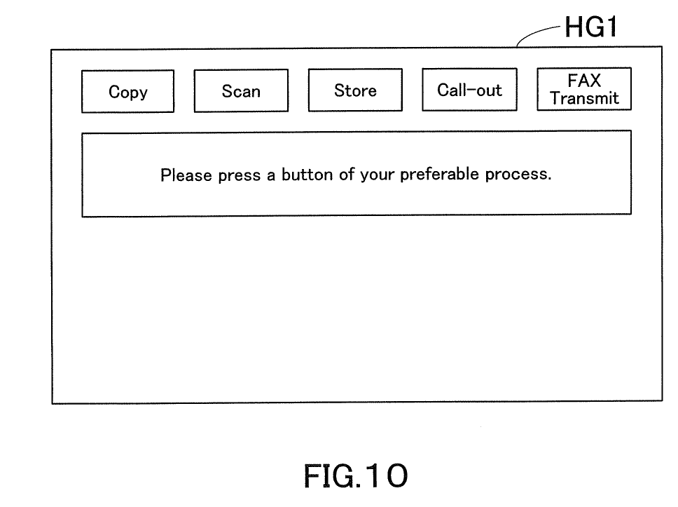

FIG. 9 is a flowchart to explain an entire procedure executed in the image forming apparatus 1. FIG. 10 is a view showing an example of an initial menu screen HG1.

When nobody operates the image forming apparatus 1 directly, the initial menu screen HG1 shown in FIG. 10 is displayed on the display 12 of the image forming apparatus 1 (in Step S1 of FIG. 9). After logging in, a user trying to operate the image forming apparatus 1 to execute a process selects a preferable process among those in the initial menu screen HG1 by pressing a button corresponding thereto.

In Step S2, it is judged whether or not a “store” button is pressed. If it is pressed (YES in Step S2), the routine proceeds to Step S3, in which a user entry process for BOX storage is performed. Then in Step S4, a user voice input process for mode setting is performed. The user entry process for BOX storage and the user voice input process for mode setting will be described later.

In Step 55, a file is generated then stored. After that, the routine proceeds to Step S6, in which image is inputted/outputted, then goes back to Step S2.

If the “store” button is not pressed in Step S2 (NO in Step S2), it is judged in Step S10 whether or not a “call-out” button is pressed. If it is pressed (YES in Step S10), a voice output process for BOX call-out is performed in Step S11. And a file is called out in Step S12, then the routine proceeds to Step S6. The voice output process for BOX call-out will be described later.

In Step S10, if the “call-out” button is not pressed, in other words, a “copy” button, a “scan” button or a “FAX-transmit” button is pressed (NO in Step S10), a process corresponding to the pressed button is performed in Step S20. After that, the routine proceeds to Step S10.

A concrete example of the corresponding process above is as described below. A screen to set conditions for a process corresponding to the pressed button (to be referred to as “a process condition setting screen”, hereinafter) is displayed, and a user is requested to enter preferable conditions. If he/she enters conditions, a job to execute the process selected via the initial menu screen HG1 is generated according to the conditions then registered into the active job database DB2 (see FIG. 7 and FIG. 8), by the job generator 101. And the job execution controller 102 controls the respective portions so that the job could be executed when its turn comes around (Step S6).

For example, if the “copy” button is pressed, under the control of the job execution controller 102, a process condition setting screen to set conditions such as sheet type, color mode, economy mode (single/double-side, scale, multi-in-one copy), applied mode (booklet, numbering) and etc. is displayed on the display 20. And a job to execute a copy process according to conditions set by user is generated then registered into the active job database DB2, by the job generator 101. When an execution turn of the job comes around, under the control of the job execution controller 102, images on a document set on the document feeder 17 are scanned by the scanner 13 and etc. then printed on recording sheets by the printer 14, according to the conditions set by user.

If the “scan” button is pressed, under the control of the job execution controller 102, a process condition setting screen to set conditions such as scanning picture quality, scanning density, single/double-side document, file format (TIFF, PDF or etc.) for file conversion of data of scanned images, destination of a converted file, and etc. is displayed. Subsequently, as in the case of the copy process described above, a job is registered into the active job database DB2. And when its turn comes around, under the control thereof, images on a document set on the document feeder 17 are scanned and a file of the images is generated by the scanner 13 and etc., then the file is transmitted to a specified destination by the communicator 16, according to the conditions set by user.

Meanwhile, users are allowed to remotely operate the image forming apparatus 1 to execute a print process, by using the client terminals 2, 3 and 4. For example, a user preliminarily opens a file of an image to be printed, sets print conditions then enters a predetermined command. And then, data for printing the image is transmitted together with information indicating the print conditions, from the client terminals 2, 3 or 4 to the image forming apparatus 1. In the image forming apparatus 1 receiving these data, as in the case of the copy process described above, a job corresponding to the print process is registered into the active job database DB2. And when its turn comes around, the print process is executed by the printer 14 and etc.

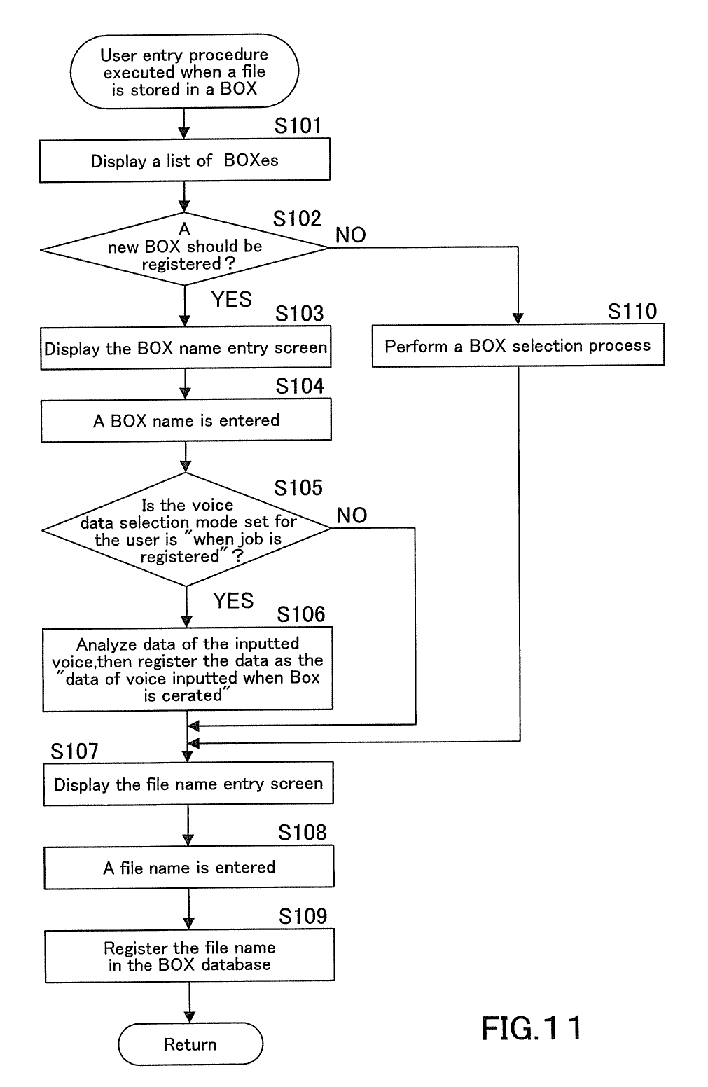

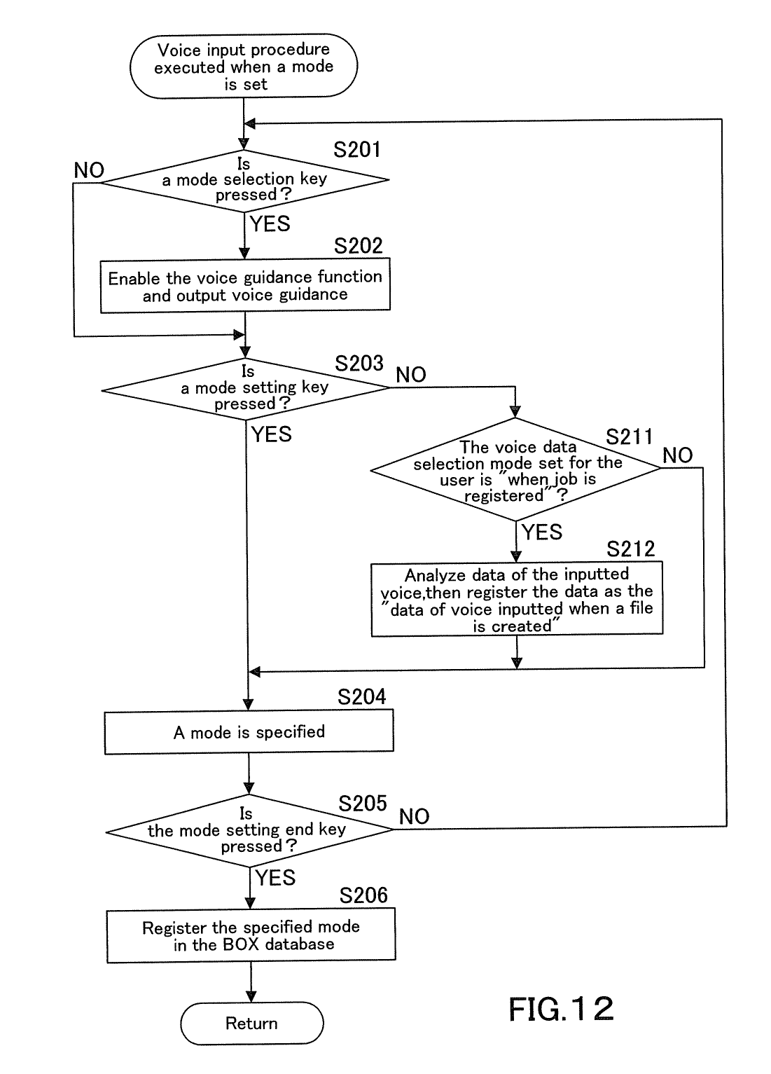

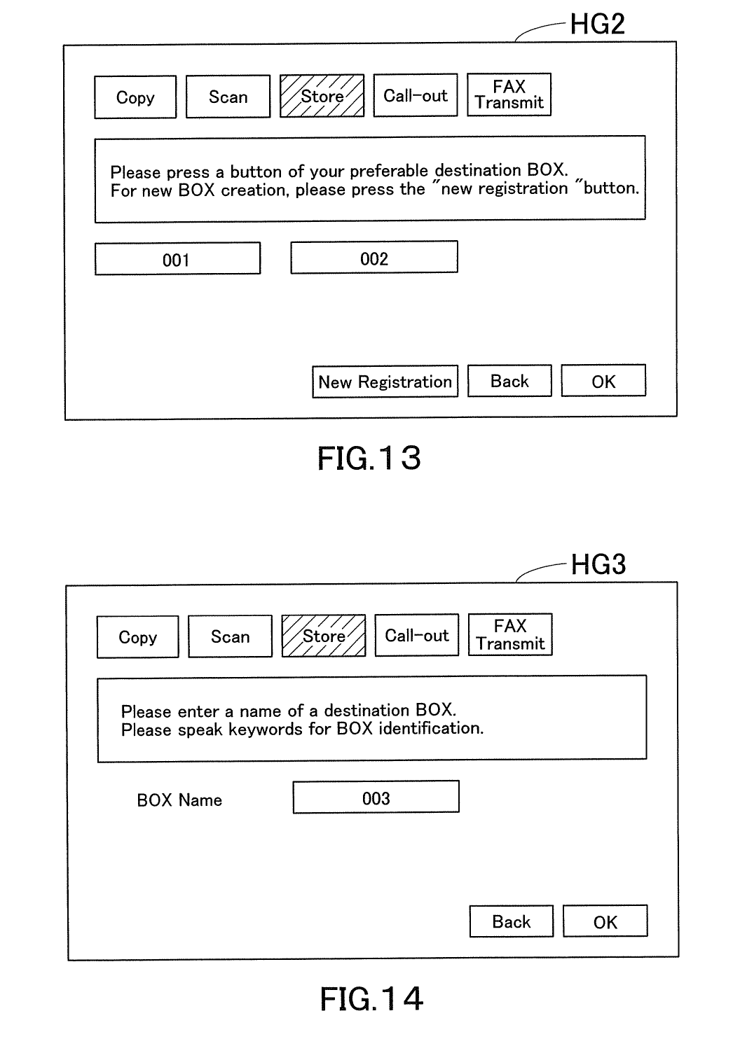

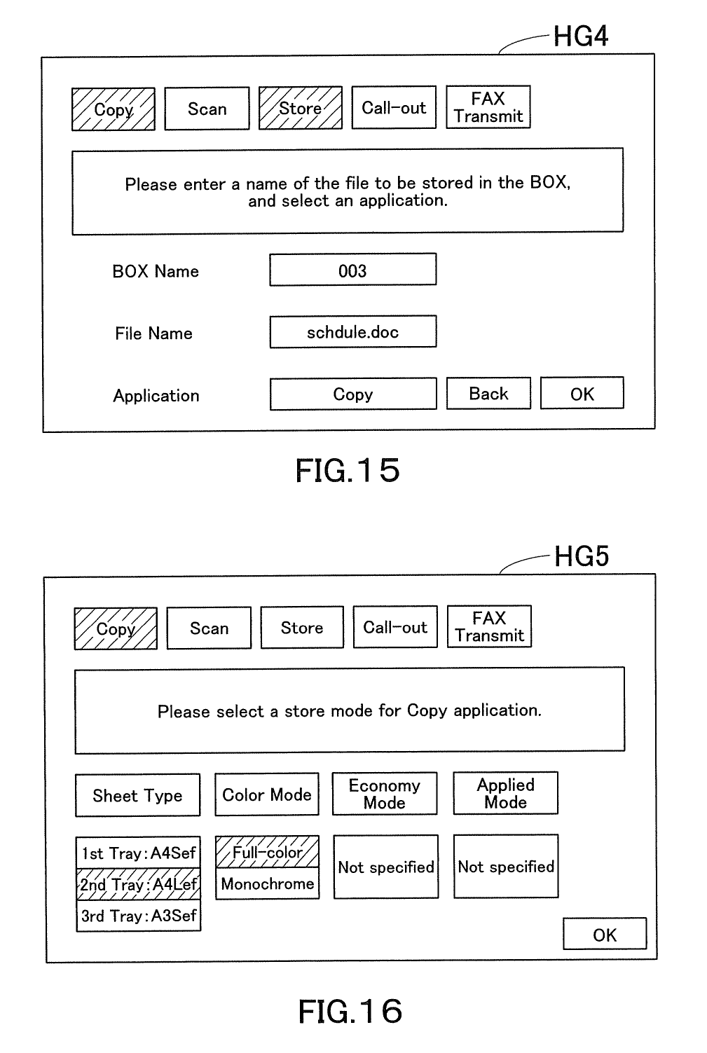

FIG. 11 is a flowchart showing a user entry procedure executed when a file is stored in a BOX, which corresponds to Step S3 of the flowchart shown in FIG. 9. FIG. 12 is a flowchart showing a user voice input/output procedure executed when a mode is set, which corresponds to Step S4 of the flowchart shown in FIG. 9. FIG. 13 is a view showing an example a BOX selection screen HG2, FIG. 14 is a view showing an example of a BOX name entry screen HG3 displayed when a new BOX name is entered, and FIG. 15 is a view showing an example of a file name entry screen HG4.

Back to the initial menu screen HG1 shown in FIG. 9, if a user presses the “store” button in addition to the “copy” button, the “scan” button or the “FAX-transmit” button (YES in Step S2), the routine proceeds to Step S101 of FIG. 11, so that a file to execute a process corresponding to the pressed button could be generated then stored in a BOX, by the file storing processor 104.

As shown in FIG. 11, initially in Step S101, the BOX selection screen HG2 shown in FIG. 13 is displayed on the display 12. In this BOX selection screen HG2, names of existing BOXes, a “new registration” button, a “back” button, an “OK” button and etc. are displayed together with a message requesting to select a destination BOX or to press the “new registration” button for new BOX creation.

Then in Step S102, it is judged whether or not a new BOX should be registered. If a user does not hope to register a new BOX, he/she selects a preferable destination BOX by pressing a button corresponding thereto. If a button corresponding to the destination BOX is pressed, then in Step S102, it is judged by the image forming apparatus 1 that a new BOX does not have to be registered (NO in Step S102), and a BOX selection process to accept the selected BOX is performed in Step S110. Then the routine proceeds to Step S107.

If the “new registration” button is pressed (YES in Step S102), the BOX name entry screen HG3 shown in FIG. 14 is displayed (Step S103). In this screen, a BOX name entry field, the “back” button, the “OK” button and etc. are displayed together with a message requesting to enter a BOX name and speak keywords for BOX identification.

And the user enters a preferable number by using keys of the operation portion 11, and also inputs keywords for BOX identification by voice if needs. After that, he/she presses the “OK” button. Then in Step S104, a BOX name entry process to accept the BOX name is performed.

Subsequently, it is judged in Step S105 whether or not the voice data selection mode set for this user in the user information database of FIG. 6 is “when job is registered”. If it is “when job is registered” (YES in Step S105), then in Step S106, data of the voice inputted in the way above is analyzed then registered as “data of voice inputted when BOX is created” into his/her BOX of the BOX database of FIG. 5.

In Step S107, the file name entry screen HG4 shown in FIG. 15 is displayed on the display 12. In this file name entry screen HG4, a BOX name display field, a file name entry field, an application entry field, the “back” button and the “OK” button are displayed together with a message requesting to enter a file name and an application. Here, an application indicates a mode to store a file.

And the user decides and enters a file name of a file to be stored, and enters a preferable application name in the application entry field, and then presses the “OK” button. Subsequently, a file name entry process to accept the entered file name is performed in Step S108, and the file name is registered into the BOX database in Step S109. In this way, a BOX that is a storage location of a file to be stored is created and a file name is set to the file.

After registration into the BOX database, the routine proceeds to Step S201 that corresponds to the user voice input/output procedure executed when a mode is set, which is shown in the FIG. 12. At the same time, a mode setting screen HG5 shown in FIG. 16 is displayed on the display 12. As shown in an example of FIG. 16, a mode setting screen supposed to be displayed if the application is “copy” is displayed thereon, and wherein, mode selection keys such as “sheet type”, “color mode”, economy mode, “applied mode” and etc., mode setting keys to set a mode for each selected mode are displayed together with a message requesting to select a store mode for the “copy” application.

In Step S201, it is judged whether or not a mode selection key of “sheet type”, “color mode”, “economy mode”, “applied mode” or etc. in the mode setting screen of FIG. 16 is pressed. If such a key is pressed (YES in Step S201), the function of voice assistance (referred to also as “voice guidance”) is enabled and a predetermined voice guidance is outputted, in Step S202. Then, the routine proceeds to Step S203.

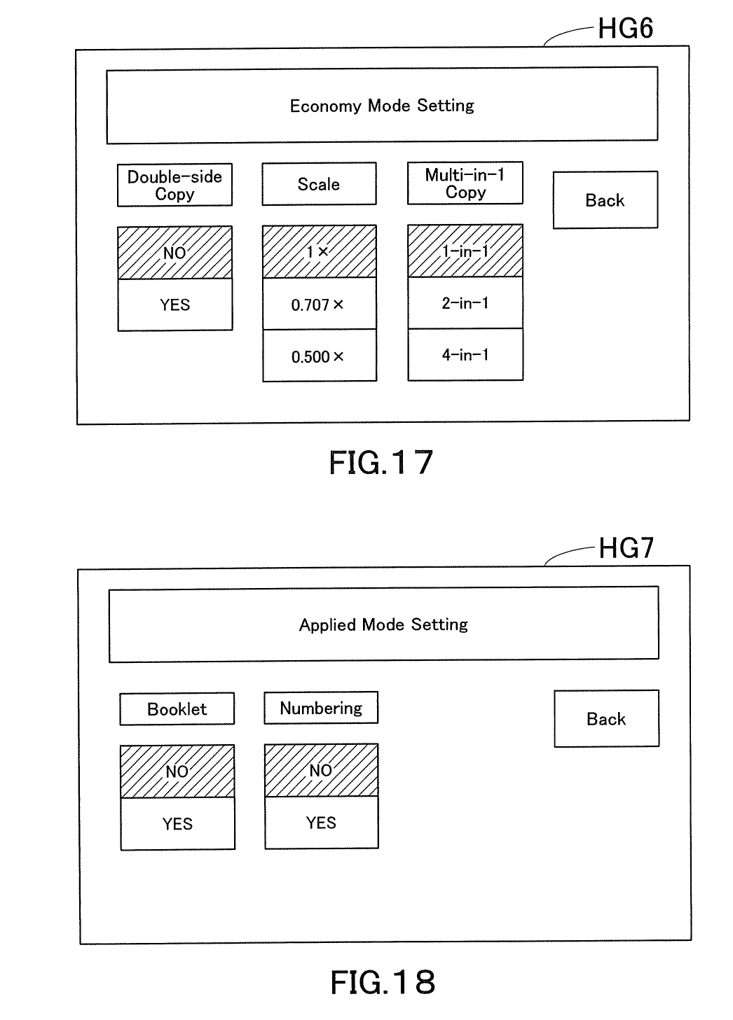

For example, if the “economy mode” key is pressed, the screen is switched to an economy mode setting screen HG6 shown in FIG. 17, then the voice guidance is outputted as “please select single/double-side, scale or multi-in-one copy”, for example. If the “applied mode” key is pressed, the screen is switched to an applied mode setting screen HG7 shown in FIG. 18, then the voice guidance is outputted as “please select booklet or numbering”, for example.

In Step S201, if a mode selection key is not pressed (NO in Step S201), the routine proceeds to Step S203 directly.

In Step S203, it is judged whether or not a mode setting key is pressed. If it is pressed (YES in Step S203), a mode corresponding to the pressed mode setting key is accepted. If a mode setting key is not pressed (NO in Step S203), then it is judged in Step S211 whether or not the voice data selection mode set for the user is “when job is registered”, according to the user information database shown in FIG. 6.

If it is “when job is registered” (YES in Step S211), voice input is enabled and data of inputted voice is analyzed then stored in the “data of voice inputted when file is created” field of the user's BOX in the BOX database shown in FIG. 12, in Step S212. Then, the routine proceeds to Step S204. In this way, when a user enables the function of voice assistance and intends to create a file, data of inputted voice is stored in the “data of voice inputted when file is created” field.

In Step S211, the voice data selection mode set for the user is not “when job is registered” (NO in Step S211), the routine proceeds to Step S204 directly. In this case, a predetermined voice will be outputted when a file is selected from a BOX.

After accepting the specified mode in Step S204, it is judged in Step S205 whether or not a mode setting end key (the “OK” button) is pressed. If it is not pressed (NO in Step S205), the routine goes back to Step S201. If it is pressed (YES in Step S205), the specified mode is registered into the BOX database in Step S206. After that, the routine returns to Step S5 of FIG. 9.

Meanwhile, if the “back” button in the screens shown in FIG. 14, FIG. 15 and FIG. 16 and the screens to be explained later is pressed, the initial menu screen HG1 is displayed again. And thus, users are allowed to start again operations such as selection about the respective items, and etc.

In Step S5 of FIG. 9, a file to execute a process selected in the initial menu screen HG1 is generated then stored with a specified file name in a BOX created in Step S3, by the file storing processor 104, as described above.

At that time, not only a file to execute a process corresponding to a button pressed in the initial menu screen HG1 is generated then stored in a BOX, but also the process may be executed immediately. Instead of executing the process immediately, the process may be executed later according to user instruction. Users can select the process should be executed whether immediately or not immediately.

Meanwhile, users can store in their own BOXes, files of images created by the client terminals 2, 3 and 4, so as to print the files by the image forming apparatus 1. In this case, a user selects an option corresponding to the “store” button in the initial menu screen HG1 when enters a command for a print process. And then, for example, a file related to print data and etc. received from the client terminals 2, 3 or 4 is generated then stored in this user's BOX, by the file storing processor 104.

When finishes using the image forming apparatus 1, users log out thereof by performing a predetermined operation. Alternatively, he/she may be forcibly logged out thereof if the non-use state continues longer than a predetermined time period.

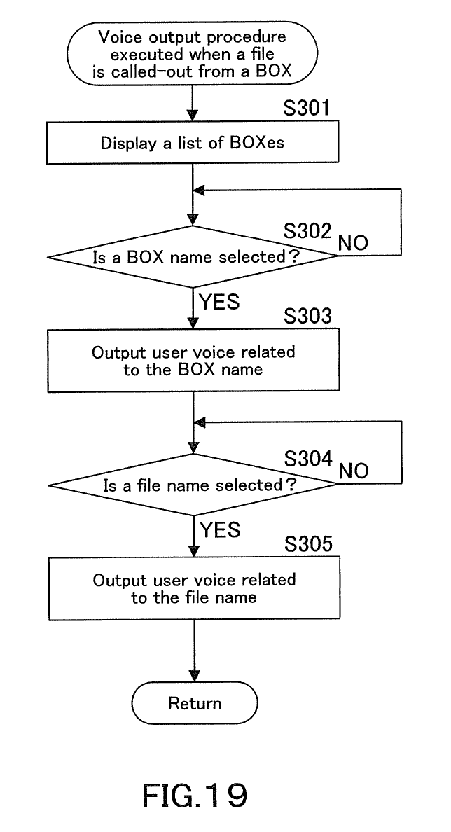

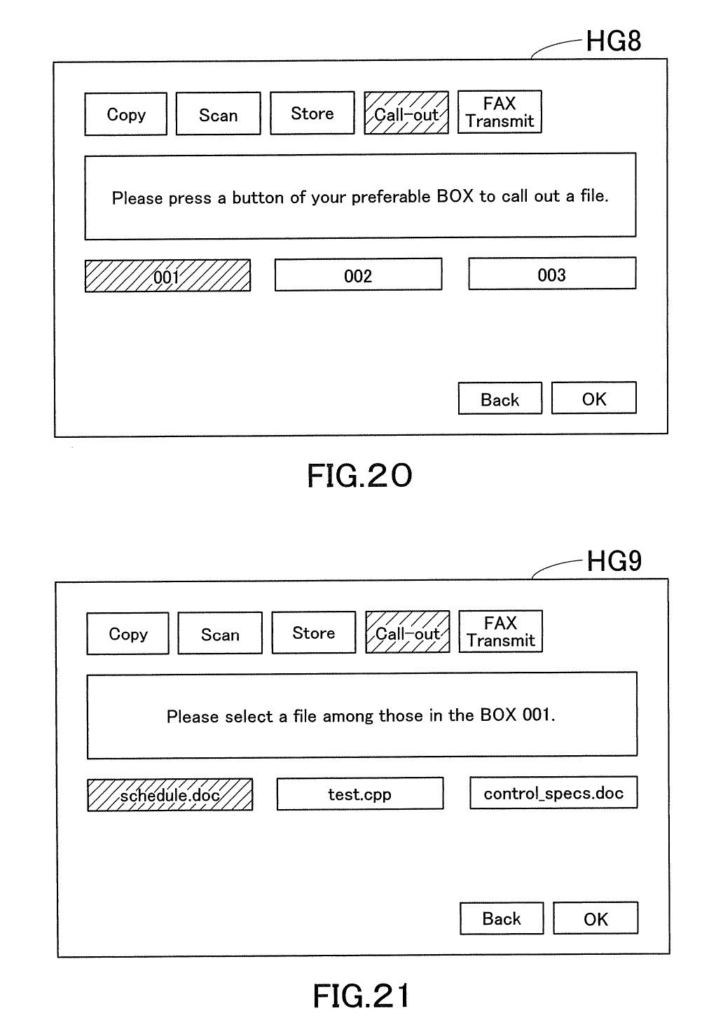

FIG. 19 is a flowchart showing a subroutine to output voice when a file is called out from a BOX, which corresponds to Step S11 of the flowchart shown in FIG. 9. FIG. 20 is a view showing a BOX selection screen HG8 to select a BOX to call-out, and FIG. 21 is a view showing a file selection screen HG9.

If a login user presses the “call-out” button in the initial menu screen HG1 shown in FIG. 10 (YES in Step S10), the BOX selection screen HG8 shown in FIG. 20 is displayed on the display 12. In this screen, a list of BOX names, the “back” button and the “OK” button are displayed together with a message requesting to select a name of a BOX to call-out.

In Step S302, it is judged whether or not a BOX name is selected by user. If it is not selected (NO in Step S302), the routine waits until it is selected. If it is selected (YES in Step S302), the routine proceeds to Step S303, in which user voice related to the BOX name is outputted and the screen displayed on the display 20 is switched to the file selection screen shown in FIG. 21. The user voice output process performed in Step S303 will be described later.

In Step S304, it is judged whether or not a file name is selected by user. If it is not selected (NO in Step S304), the routine waits until it is selected. If it is selected (YES in Step S304), the routine proceeds to Step S305, in which user voice related to the file name is outputted. After that, the routine returns to Step S12 of FIG. 9.

Hereinafter, the process of outputting user voice related to the BOX name, which corresponds to Step S303, and the process of outputting user voice related to the file name, which corresponds to Step S305, will be explained.

There are two methods for voice output, depending on settings of the “voice data selection mode” in the user information database shown in FIG. 6.

Initially, a first method will be explained as following. If the “voice data selection mode” set for a user is “when user is registered”, voice data registered as this user's “voice data for BOX selection” in the user information database is called out then outputted. For example, if a BOX of the user MORIKAWA is selected, the voice guidance is outputted as “a BOX of MORIKAWA is selected”.

In the same way, if a file of MORIKAWA is selected, voice data registered as this user's “voice data for file selection” in the user information database is called out then outputted. For example, the voice guidance is outputted as “a file of MORIKAWA is selected”.

A second method will be explained as following. If the “voice data selection mode” set for a user is “when job is registered” and a BOX of TANAKA is selected for example, data registered as his/her “data of voice inputted when BOX is created” is called out from the BOX database shown in FIG. 5, and then the voice guidance is outputted as “this is a BOX related to management of Development Section No. 11”. In this way, voice to identify a selected BOX is outputted, and thereby users can recognize the BOX more surely.

Meanwhile, if a file of TANAKA is selected, data registered as his/her “data of voice inputted when file is created” is called out from the BOX database shown in FIG. 5. And then, since the “selection of data pickup mode” set for the user is “pickup”, shortened registered data is outputted by voice as “copy, double-side” only, for example. In other words, voice guidance shortly explaining a job to be executed about the file is outputted.

If the “selection of data pickup mode” set for the user is “no pickup”, entire voice registered as his/her “data of voice inputted when file is created” is outputted.

The “selection of data pickup mode” is preliminarily set via an administrator mode setting screen to be described later, according to preferences of users: who hope to make sure the entire configured data and who hope to make sure only basic modes among those.

As described above, when a login user selects a BOX or a file, guiding voice data set for the user is selected among those recorded in the BOX database or in the user information database of the hard disk 23H, then voice corresponding to the selected guiding voice data is outputted by the voice output portion 34. Thus, information is given by voice inputted individually by login users, in other words, users can obtain information by voice in an easy-to-understand and easy-to-hear manner.

Back to Step S12 of FIG. 9, an image file stored in the BOX specified in Step S11 is called out. Then, a job to be outputted is generated then registered into the active job database DB2 shown in FIG. 7, in Step S6. When an execution turn of the job comes around, under the control of the job execution controller 102, the file specified in Step S11 is called out, and the job is executed about the file by the printer 14, the communicator 16 or etc. according to its job type (copy, scan and transmit, or etc.)

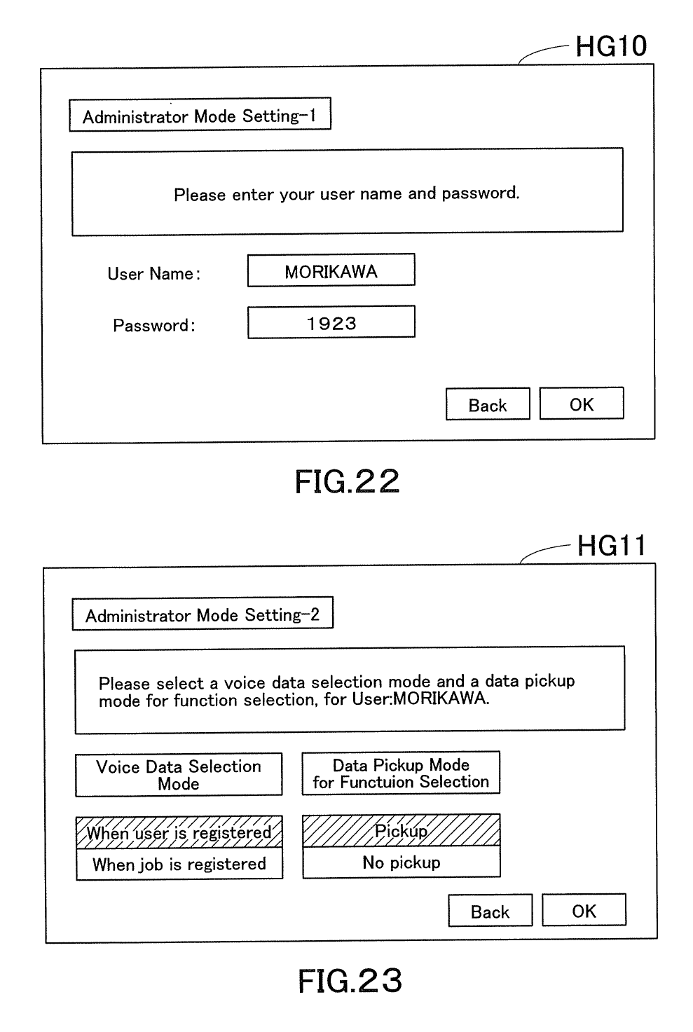

FIG. 22 shows an example of the administrator mode setting screen HG10 to register data for respective users. Preferable user names and passwords are inputted via this screen for registration. Inputted passwords are registered into the user information database.

FIG. 23 shows an example of an administration mode setting screen HG11 to register data for respective users. Via this screen, the “voice data selection mode” can be set as “when user is registered” or “when job is registered” and the “data pickup mode for function selection” can be set as “pickup” or “no pickup”, for the user specified in the administrator mode setting screen HG10 above. The configured setting is registered into the user information database.

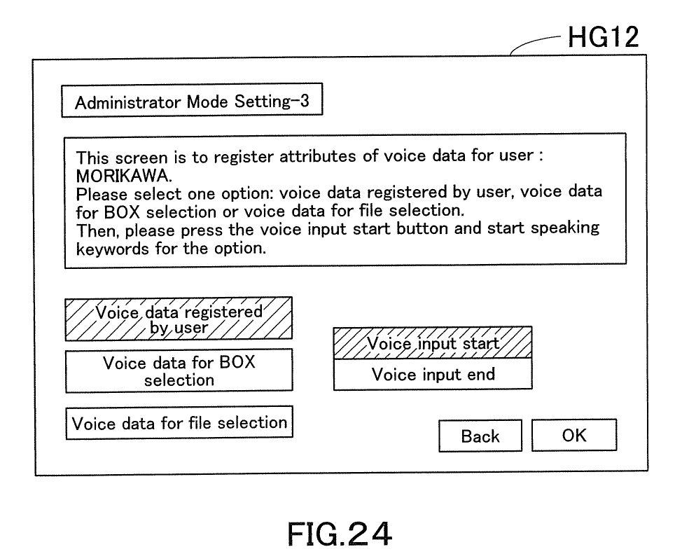

FIG. 24 shows an example of an administrator mode setting screen HG12 to register voice data for respective users. Via this screen, the “voice data registered by user”, “voice data for BOX selection” and “voice data for file selection” can be inputted by the voice input portion 31, for the user specified in the administrator mode setting screen HG10 above. The inputted voice data is registered into the user information database.

When the “voice data registered by user” is inputted, acoustic features (sound characteristics) and rhythmic features (length, pitch, intensity of sound) are extracted and registered into the database at the same time, by operation of the voice information characteristics extractor 32.

Therefore, if there is the “voice data registered by user” registered in the database, the following processes can be performed. That is, if the user MORIKAWA logins and selects the BOX “002” which BOX creator is TANAKA, since the voice data selection mode set for MORIKAWA is “when user is registered”, the voice registered as the “data of voice inputted when BOX is created” of the BOX “002” shown in FIG. 5, may be changed to other voice having MORIKAWA's characteristics based on the “voice data registered by user” set for MORIKAWA, then outputted as “this is a BOX related to management of Development Section No. 11”.

Concretely, acoustic and rhythmic features extracted when user voice is registered, are picked up from the BOX of MORIKAWA in the BOX database, and the voice is synthesized from the data of TANAKA's voice then outputted, by operation of the voice information synthesizer 33.

As described above, users using the MFP are always allowed to make sure by their own voice what is registered, which would improve usability of the MFP.

Furthermore, if the voice having MORIKAWA's characteristics, which is changed based on the “voice data registered by user” registered in advance, is still hard to hear, he/she can register “voice data registered by user” again via the administrator mode setting screens, in order to hear more preferable voice having his/her characteristics.

Meanwhile, the image forming apparatus 1 has a program to transmit to the client terminals 2, 3 and 4 screen data of screens equivalent to the respective screens displayed on the display 12, and a program to receive from the client terminals 2, 3 and 4 information inputted via these screens, installed thereon. And thereby, users using client terminals 2, 3 and 4 are allowed to remotely operate the image forming apparatus 1 to call out a file stored in a BOX and execute a preferable process.

All of the above explanations relate to one embodiment of the present invention. However, the present invention is not limited to this embodiment above. In this embodiment, information is given by appropriate voice for respective login users when a BOX or a file is selected for example. However, the timing of giving information by voice is not limited to that of this embodiment. For example, voice data may be preliminarily inputted when execution of a job is started, then outputted when a job confirmation key is pressed. Alternatively, information may be given by appropriate voice for respective login users when another operation is performed.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. An image processing apparatus comprising:
a voice input portion;
a memory that stores in itself as voice data, voice of a plurality of users for voice assistance, which is inputted by the voice input portion;
a selection portion that selects voice data applied for a login user among the voice data stored in the memory, if information should be given by voice; and
a voice output portion that outputs voice corresponding to the selected voice data.

2. The image processing apparatus recited in claim 1, wherein the voice outputted by the voice output portion corresponds to voice inputted when at least one function which information should be given by voice is specified by user.

3. The image processing apparatus recited in claim 1, wherein the voice outputted by the voice output portion corresponds to voice inputted when the user is registered.

4. The image processing apparatus recited in claim 1, wherein information is given with voice assistance when a preferable memory area is selected among a plurality of memory areas created in the memory, and the voice outputted by the voice output portion serves for identifying the selected memory.

5. The image processing apparatus recited in claim 4, wherein the voice outputted by the voice output portion corresponds to voice inputted when the memory area is created or when the user is registered.

6. The image processing apparatus recited in claim 1, wherein information is given with voice assistance when a file is selected among files stored in the memory, and the voice outputted by the voice output portion serves for explaining a job to be executed about the file.

7. The image processing apparatus recited in claim 6, wherein the voice outputted by the voice output portion corresponds to voice inputted when the file is created or when the user is registered.

8. The image processing apparatus recited in claim 1, wherein the voice outputted by the voice output portion corresponds to a part picked up from voice inputted when at least one function which information should be given by voice is specified by user.

9. A voice assistance method comprising:
storing in a memory as voice data, voice of a plurality of users for voice assistance, which is inputted by a voice input portion;
selecting voice data applied for a login user among the voice data stored in the memory, if information should be given by voice; and
outputting voice corresponding to the selected voice data.

10. The voice assistance method recited in claim 9, wherein the outputted voice corresponds to voice inputted when at least one function which information should be given by voice is specified by user.

11. The voice assistance method recited in claim 9, wherein the outputted voice corresponds to voice inputted when the user is registered.

12. The voice assistance method recited in claim 9, wherein information is given with voice assistance when a preferable memory area is selected among a plurality of memory areas created in the memory, and the outputted voice serves for identifying the selected memory.

13. The voice assistance method recited in claim 12, wherein the outputted voice corresponds to voice inputted when the memory area is created or when the user is registered.

14. The voice assistance method recited in claim 9, wherein information is given with voice assistance when a file is selected among files stored in the memory, and the outputted voice serves for explaining a job to be executed about the file.

15. The voice assistance method recited in claim 14, wherein the outputted voice corresponds to voice inputted when the file is created or when the user is registered.

16. The voice assistance method recited in claim 9, wherein the outputted voice corresponds to a part picked up from voice inputted when at least one function which information should be given by voice is specified by user.

17. A computer readable recording medium having a voice assistance program recorded therein to make a computer of an image processing apparatus execute:
storing in a memory as voice data, voice of a plurality of users for voice assistance, which is inputted by a voice input portion;
selecting voice data applied for a login user among the voice data stored in the memory, if information should be given by voice; and
outputting voice corresponding to the selected voice data.
